(19) United States
(12) Patent Application Publication
(10) Pub. No.: US 2007/0028729 A1
(43) Pub. Date: Feb. 8, 2007

(54) Infeed system with automated workpiece orientation

(75) Inventor: Bradley Quick, Staatsburg, NY (US)

Correspondence Address: STEPHEN B. ACKERMAN, 28 DAVIS AVENUE, POUGHKEEPSIE, NY, 12603, US

(73) Assignee: James L. Taylor Manufacturing Co.

(21) Appl. No.: 11/199,328

(22) Filed: Aug. 8, 2005

(51) Int. Cl. B26D 7/06

(52) U.S. Cl. 83/13; 83/418; 83/367

(57) ABSTRACT

An apparatus and method for automatically adjusting the orientation of a workpiece before feeding the workpiece to a saw. The apparatus includes a first conveying means for moving a workpiece transversely while measuring the profile every foot for the length. Stopping the workpiece to automatically adjust the workpiece by vertically lifting one end and horizontally moving the other end.

### BACKGROUND OF THE INVENTION

(1) Technical Field

This invention relates generally to an infeed method and apparatus for conveying individual lengths of woodpieces to wood cutting equipment, and more particularly, to improving the alignment of woodpieces on a servo-driven belt conveyor.

(2) Description of the Prior Art

The following 5 documents relate to apparatus for infeeding articles onto a conveyor for transport.

U.S. Pat. No. 6,520,228 issued Feb. 18, 2003 to Kennedy, et al. describes a method of position-based integrated motion controlled curve sawing including scanning the workpiece through an upstream scanner to measure workpiece profiles in spaced apart array, along a surface of the workpiece and communicating the workpiece profiles to a digital processor.

U.S. Pat. No. 6,199,463 issued Mar. 13, 2001 to Quick describes an apparatus and methodology for infeeding workpieces to a saw.

U.S. Pat. No. 6,178,858 issued Jan. 30, 2001 to Knerr describes a shape sawing system using a scanner to scan cant portion as it is conveyed on a conveyor system and inputs the scan data into a computer.

In operations involving the sawing of wood in, for example, sawmills, or in processing for the production of furniture, several considerations are taken into account in cutting wood economically. These include the timing with which the wood is fed to gang saws, the safety of the workers who are responsible for loading the wood onto the conveyor, and the number of workers required for the operation. For efficient operation, modern wood machining systems require substantially continuous processing of relatively large volumes of wood. Accordingly, gang saws, and other machining apparatus, capable of operating at high sawing rates have been developed. In order to fully utilize the high sawing speeds, however, wood delivery systems must be capable of providing such apparatus with wood at the relatively rapid rate at which the machining apparatus is processing the wood.

Another important consideration is the optimal way in which an incoming piece of wood stock of irregular shape can be cut to reduce waste. Typically, a log is first cut lengthwise along a number of parallel, axial planes to yield a number of irregularly shaped planks sometimes referred to as “cants”. Cants cut from the same log all have the same length. However, the height (or width, when later placed flat on its broad side) of each cant will vary depending upon where on the diameter of the log the cut is made. Furthermore, the thickness of each plank will be determined by the spacing of saw blades, if the log is cut in a gang saw. Usually, when cutting planks or cants from the same log, the blades are set equidistant from each other so that the resulting planks all have the same thickness. While the thickness of each cant is therefore the same in this arrangement of the blades, the height of each cant, will vary depending upon the particular section of the log is cut. For example, cants, which are cut from sections close to the center of the log, as in a circle, will be higher than those cut near its outer periphery. Moreover, the cants will generally taper in one direction corresponding the lessening diameter of the tree toward its top.

The prior art also provides movable clamping devices for clamping and positioning boards from below. However, these devices have the disadvantage of having high maintenance needs because the longitudinal feeding chains used to propel boards into the saws have to follow a complicated path around and below each clamping device.

Another example is U.S. Pat. No. 6,199,463 B1 (Quick), herein incorporated by reference in its entirety, also assigned to the present assignee, discloses an automated infeed system. Referring to FIG. 1 and FIG. 2 there is provided an apparatus for automatically infeeding workpieces 90 to a fixed arbor rip saw 170. The apparatus having a means for selecting one of a plurality of the workpieces 90 at an input station 110. A servo-driven friction belt system 123 is connected to the input station 110, and advances the workpiece under a pattern projection system (not shown). The projection system causes a pattern of lines to be projected onto the workpiece, the pattern corresponding to one of a plurality of patterns representing the blade configuration of the fixed arbor gang rip saw 170. Finally, there is a pinch roller system 161, 162 used for removing the workpiece from the friction belt system and moving the workpiece into the saw, while maintaining the workpiece's original orientation under the pattern. Also provided is a sensor for measuring the board width while moving on the servo-driven friction belt system, where the width is input to a computer controlling the friction belt system and which determines the optimum pattern.

The present invention has been developed to provide a novel approach for automatically adjusting the orientation of a workpiece. After a workpiece is released to a first conveyor, the workpiece passes by a scanning means to identify the dimensional characteristics of the workpiece. This information is stored in a computer and analyzed for the most efficient workpiece alignment for sawing. The workpiece moves longitudinally into a vertical lift area. One end of the workpiece is raised off all the belts of the first conveyor while the other end stays in contact. The belt, in contact with the other end, is moved in a direction, ordered by the computer, adjusting the workpiece for the most advantageous alignment for sawing. The belts are driven by a servo system that includes a servomotor and a rotary encoder combination which are in a closed loop configuration with the computer. The raised end of the workpiece is lowered and conveyed longitudinally in its adjusted position to a second conveyor for infeeding the workpiece into fixed arbor gang rip saws without the complications associated with prior art workpiece alignment apparatus and methods of operation. The disclosed apparatus together with its new method of application bring much needed improvements to wood cutting operations, as discussed more in details below.

### SUMMARY OF THE INVENTION

It is therefore an object of this invention to provide an improved apparatus for automated feeding of a workpiece to a fixed arbor gang rip saw.

It is another object of this invention to provide an apparatus and method for selecting and maintaining a board orientation for feeding to a gang rip saw.

It is another object of this invention to provide an automated system that is ergonomically efficient and safe to operate.

It is yet another object of this invention to provide an automated infeed system having a low labor cost by reducing the manual tasks associated with manually adjusting the orientation of the workpiece prior to sawing.

It is still another object of this invention to provide an improved apparatus for optimizing the sawing of woodpieces.

It is still another object of the invention to provide an automated infeed system having a low cost simple method for selecting a board cutting pattern and advancing the board to a gang rip saw while maintaining a selected board orientation.

In accordance this aforementioned objects, there is provided an apparatus for automatically infeeding workpieces to a saw, under control of a computer. A first workpiece is manually placed on a load conveyor then released to a first conveying means. The width of the first workpiece is measured, and the workpiece is advanced under a projected pattern, the pattern based on the workpiece width and on optimizing yield. An operator may select an alternative pattern by moving the workpiece under the alternative patterns. An operator may also skew the first workpiece. The first workpiece is submitted to the saw input while maintaining the desired skew.

### DESCRIPTION OF THE DRAWINGS

FIG. 1 is a plan view showing a sawing system of the prior art.

FIG. 2 is a side elevation view of the prior art sawing system.

FIG. 3 is a perspective view showing an overview of an semi-automated infeed system according to the invention.

FIG. 4 illustrates an overhead view of the automated infeed system according to the invention.

FIG. 5 is a side view of the automated infeed system according to the invention.

FIG. 6 illustrates a front view of the semi-automated infeed system with a workpiece being conveyed transversely according to the invention.

FIG. 7 illustrates an overhead view of the semi-automated infeed system with a workpiece raised for adjustment according to the invention.

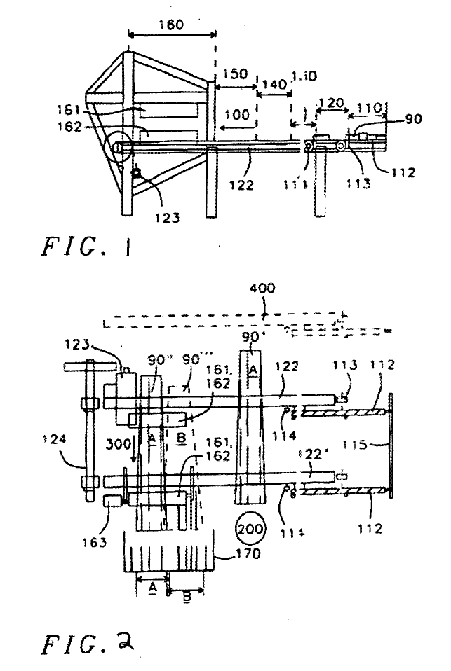

### DETAILED DESCRIPTION OF THE PREFERRED EMBODIMENT

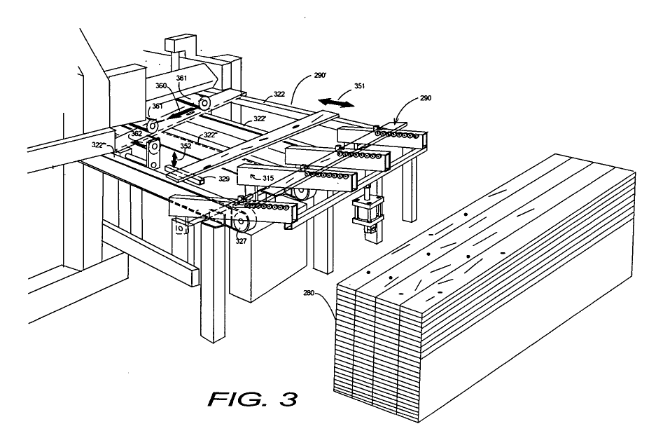

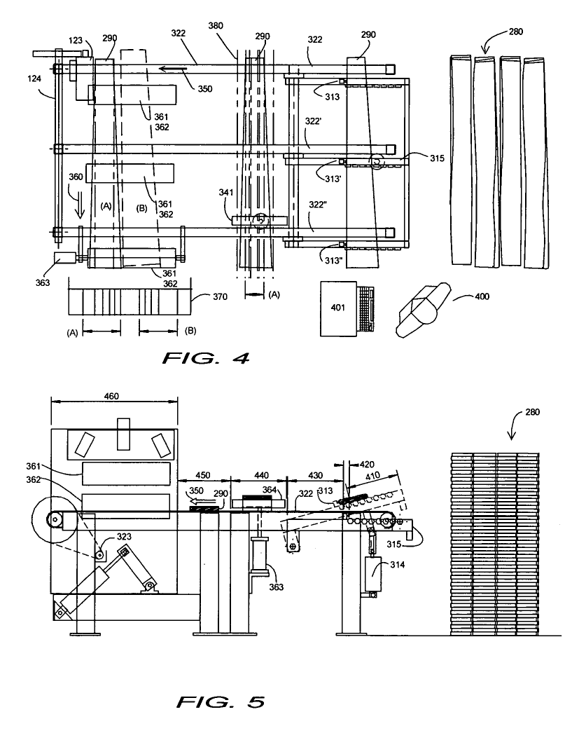

Referring now to the drawings, in particular to FIGS. 3, 4 and 5. FIG. 3 is a perspective illustration, FIGS. 4 and 5 show top and side views respectively, of the automated infeed system constructed according to the principles of the present invention. An operator 400 removes a workpiece 290, from a supply pile 280, and places it onto a ramp conveyor 315. The workpiece slides to a pick-up station 420. The operator releases the workpiece to a first conveyor to be conveyed past a width measuring station 430 and a projection and optimization area 440. The workpiece continues its excursion past a clear area 450 and then to a saw feeding area 460. Fixed arbor gang ripsaws 370 are shown in the plan view of FIG. 3. Thus boards 290 to be processed progress from right to left in direction 350 on a series of belts 322 until they reach the saw area 460. That is, as will be described in more detail shortly, the boards travel broadside until they are picked up by pinch-rollers 361 and 362 at which time they are fed lengthwise in direction 360 into the gang rip saw blades 370, with details of the pinch roller arrangement shown in FIG. 5. The sawed boards are then transferred away from the sawing system for further processing.

It will be observed in FIG. 3 that the transfer of boards from loading station 410 to the saw area 460 is accomplished by means of a series of roller tracks 315 coupled by tie-bar of which 3 sets are shown for purposes of illustration. The number and spacing of tracks 315 and belts 322 is not fixed but depends on such parameters as the board's length being processed and available floor space, etc. By way of example, six sets of roller tracks and belts may be used, spaced apart at three-foot intervals. In such a setup, boards as long as 18 feet can be processed.

Considering now in more detail the operation of the auto infeed system of the present invention, boards 290 are input at load station 410 on a movable structure 315. Shown in FIGS. 3, 4, 5 and 6, an operator 400 removes a workpiece 290 from a supply pile 280 and places it on the movable structure 315. The movable structure has a fulcrum end and a movable end, this is best illustrated in FIG. 5. The movable structure is in a normally ramped stance, shown in broken lines, is positioned by an extended linear actuator 314. The workpiece slides, assisted by gravity, while aligning itself against mechanical steps 313. The linear actuator is retracted to bring the movable structure down to a horizontal position, as shown in FIG. 5, so that the workpiece rests on a parallel series of first belt conveyors and released as mechanical stops 313 are lowered, by pivoting movable structure 315, below the top driving surfaces of the series of belts 322, 322′ and 322″. When movable structure 315 lowers to a horizontal position, the advancing workpiece is picked up simultaneously by the first belt conveyor, and driven in the direction of 350.

The belt conveyor is driven by a single servomotor 123, which is connected, to a shaft 124 that is common to all the belts. Such mechanical connections are well known in the art and as they are not significant to the invention are not described here in detail.

The first belt conveyor is commanded from an operator controlled console 401 shown in FIG. 4. The inner surface (opposite to the surface contacting the workpieces) of the belts have teeth to engage sprockets on the shaft 124, to allow for precise movement of the boards. The belt teeth are preferably composed of polyurethane. On the opposite side of the belt, a high degree of friction is required between the belt and boards a rubber material is preferred, such as Linatex (M) rubber.

Operator 400 releases the workpiece, one at a time, on the servo-controlled series of belts. After leaving stops 313, a selected wood piece is smoothly accelerated to be processed past multiple sensors (not shown) located within sensor area 430, where the board profile is measured every foot for the length of the board by means of, for example, a thru-beam type of optical sensor, coupled with position feedback operation from the servo motor driving the belts. One such sensor is the Omron (™) model E3S-AT91.

As the board 290(a) is smoothly accelerated and then decelerated toward projection area 440, the measured width of the board is compared with all possible rip patterns, for example fifty such patterns, that are stored in the computer memory of console 401 and which correspond to the existing arbor gang saw configuration 370. The workpiece is moved and stopped under a series of laser guide lines 380 projected onto the workpiece from above (not shown), giving the operator a projected template of possible and optimum rip combinations based on its measured width.

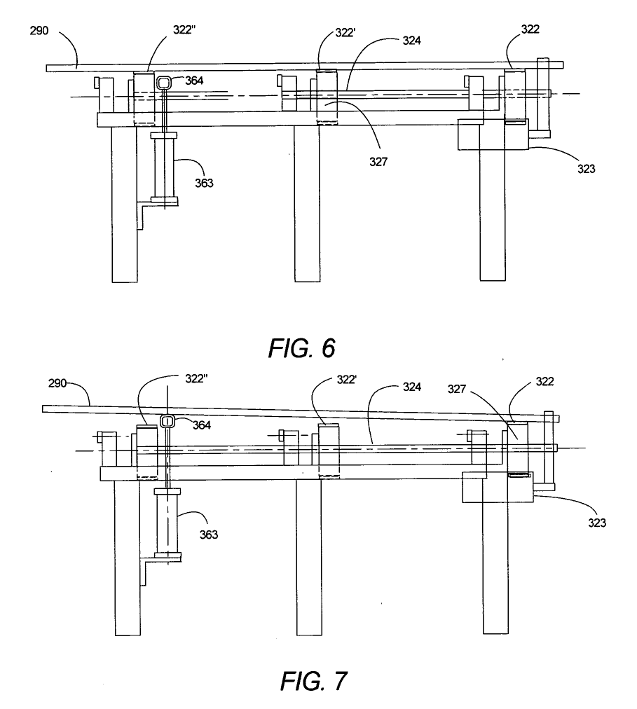

Referring now to FIGS. 6 and 7, illustrating a front view of the semi-automated infeed system. In FIG. 6, workpiece 290 is shown resting on the drive surfaces of belts 322, 322′ and 322″. A workpiece lift member 364, connected and guided by linear actuator 363, is shown in its retracted position below the drive surface plane of the belts. This is the normal conveying position for the workpiece. FIG. 7, on the other hand, shows the proximal end of the workpiece, the end closest to the operator, lifted from contact with belts 322′ and 322″ by means of the extended linear actuator 363, while the opposite end of workpiece 290 rests in contact with a drive belt 322. This novel arrangement, controlled by the computer, changes the orientation of the workpiece by jogging the servomotor 323, there-with, skewing the workpiece for alignment with the projected template.

For purposes of illustration, gang saw 370 is comprised of nine blades, which are spaced arbitrarily. It will be appreciated that many different combinations of rip patterns can be achieved with the given blades. Only two simple pattern (A) and (B) are presented here as shown in FIG. 4. Thus, when board 290(a) arrives at projection area 440, the board is automatically and accurately positioned under a series of projected lines that represent the current arbor configuration, presenting the operator with a calculated optimum rip combination based on the measured width.

Assuming, for example, board 290(c) is automatically positioned for the optimum pattern (A) that will result in maximum yield (i.e., least scrap) as shown in FIG. 4, and the operator accepts it as such, he presses a control on console 401, and the belts then move and position the board in front of the rip saw keeping it in the same relative position and orientation. Three sets of two pinch rollers 361 and 362, which are actuated by pistons (not shown) then capture the board and feed it into the gang rip saw 370. In a preferred embodiment, the top pinch rollers are driven by the pistons against the board which is in turn driven against the bottom pinch rollers, and then the pinch rollers nearest the saw are driven by motor 363 to advance the board into the saw. It will be understood by those skilled in the art that the bottom pinch rollers may instead be driven to capture the board, or alternately that both the bottom and top pinch rollers may be driven.

The actual rip pattern (A) is shown to the operator by means of visible projected lines 380 on the board at the projection area 440 (and on the computer screen at console 401, though the operator would typically rely on the projected pattern). Various systems known in the woodworking industry may be used to project lines on the boards, such as a shadowbox (in which a bright light is projected against a series of strings to create line shadows) or a laser system having one laser per line. A preferred laser unit is Lumber Line Lasers by John McCormick & Sons.

For each board, the operator is able to choose from many alternate rip patterns. For example, if a different pattern (B) appears preferable to the operator, perhaps to avoid ripping through a knot which would have resulted from using pattern (A), then he can choose that pattern and direct the system to align the board and present it to the saw accordingly as board 290(b) with pattern (B) in FIG. 4. The computer will at the same time post the calculated yield on the screen for that particular pattern. The operator can, by manipulating the board by hand, or by turning an adjustment knob on console 401 to fine tune the positioning of the board.

In one key aspect of the invention, the operator may also manually skew the board at an angle other than perpendicular to the belts to, for example, avoid a knot or split in the board. Once the desired rip pattern and skew are determined, the operator advances the board to area 460 for pick-up by the pinch rollers 361 and 362. The friction belts 322 maintain the skew angle, and smoothly position the board for the desired rip pattern. This is in contrast to the related art systems, which use a fence (thus providing for perpendicular orientations only) or a complex arrangement of alignment pins.

For each board 290, therefore, two moves are commanded by the automated infeed system. The first move positions the visible board 290(a) at the projection area 440 to show the operator the computer solution for the optimum yield. The second move positions the same board 290(b) in the pinch rollers 361 and 362 to match the arbor configuration with the chosen pattern.

Those will appreciate it skilled in the art how several important attributes of the present invention add to its simplicity. Firstly, given the sequence of operation, the use of a two position roller structure, pivoted by a linear actuator to a first load position, such that a board 290 placed on it will slide roll (assisted by gravity) squaring against stops, and then pivoted to a second position to release the board to a first belt conveyor. The use of the two-position roller conveyor is ergonomically designed for an operator to single handedly load the boards 290 from a supply pile 280 and to control the automatic infeed operation. Secondly, by the use of an industrial servomotor 123 which quickly and accurately positions the boards on the disclosed auto infeed system. In the preferred embodiment, the servomotor is a Kollmorgen # M605D-A. The servomotor allows the disclosed system to feed the ripsaw without using a fence, as noted above. This allows lumber to be fed in any orientation resulting in increased yield.

The control system of console 401 shown in FIG. 4 is typically a microprocessor based system having software developed specifically for the real time control of the apparatus of the present invention. Such control systems are commercially available and need not be described in detail. The control of mechanical systems is typically accomplished through digital to analog converters, have through direct digital digital-controlled servo actuators. Other direct digital outputs, such as a shaft encoder for determining the position of the belt conveyor, may also be employed. Such control instrumentation, included within console 401 in FIG. 4 is all within the scope of the art and will not be further described.

Once the various measurements such as width and length of boards are received by the computer, the software program calculates useful parameters such as yield, lineal feed and board length. While processing lumber, the computer constantly displays the yield data for the board being processed as well as the entire batch of lumber. As stated herein, the width measurement is accomplished by means of a sensor and is recorded by a counter. The length may be determined by various means, as is known in the art, such as through the use of another roller (not shown), subjacent to the pinch roller 362, that is used to calculate the board length by counting roller rotations as the board is being fed to the gang rip saw.

Other parameters that are determined by the computer include the optimum use of the board based on current value of different board sizes. The value data for lumber can be periodically fed into the computer and used to optimize the desired cut. The operation of the automated infeed system disclosed in this invention is a fully integrated system comprising the computer, feedback instrumentation on the floor, and the operator's console 401.

The invention offers advantages over the prior art in providing a low-cost, simplified method and apparatus for the loading and cutting of wood pieces when using a gang rip saw. It provides additional flexibility in the manufacturing environment for optimizing yield.

The objects of the invention are achieved. The disclosed infeed system automatically adjusts the orientation of a workpiece before feeding the workpiece into a saw. One end of the workpiece is lifted vertically while its opposite end is moved horizontally by a first conveying means. The conveying means includes one or more chains or belts. One end of the workpiece is lifted vertically by a fluid activated cylinder. The dimensional characteristics of the workpiece are first acquired by traversing the workpiece past a plurality of sensors and storing the measurements on a computer. The computer controls the vertical lifting and the horizontal movement.

The operating sequence is as follows. The edge detection means comprises multiple sensors for measuring dimensional characteristics of the workpiece, and storing its measurements on a computer. The first conveyor means accurately moves the workpiece under a series of laser lights, the laser lights projecting a visible plurality of parallel lines onto surface of the workpiece showing the operator an optimum rip combination based on a measured width of the workpiece. The first conveying means, under computer control, moves the workpiece tranversely past the edge detectir, to a laser light projection and alignment station. The alignment station includes a support bar that is mounted to a computer controlled linear actuator for vertically lifting one end of the workpiece. The computer also controls the horizontal movement of the other end of the workpiece which is still in contact with the first conveying means. After the workpiece is automatically aligned, the linear actuator lowers the support bar allowing the operator to release the workpiece to the second conveying means for sawing. During the vertically lifting and horizontal movement of the workpiece, the operator may choose to fine tune the positioning of the workpiece prior to releasing the workpiece to the second conveying means. The workpiece, there-after, is moved to the second conveyor for infeeding the workpiece to the saw.

While the invention has been particularly shown and described with reference to the preferred embodiments thereof, it will be understood by those skilled in the art that various changes in form and details may be made without departing from the spirit and scope of the invention.

What is claimed is:

1. An apparatus that automatically adjusts the orientation of a workpiece before feeding said workpiece into a saw.

2. The apparatus of claim 1, wherein one end of said workpiece is lifted vertically and an opposite end of said workpiece is moved horizontally

3. The apparatus of claim 2 wherein a conveying means is used to move said opposite end horizontally.

4. The apparatus of claim 3 wherein said conveying means comprises one or more chains or belts.

5. The apparatus of claim 2 wherein said one end of said workpiece is lifted vertically by a fluid activated cylinder.

6. The apparatus of claim 2 wherein dimensional characteristics of said workpiece are first acquired by traversing said workpiece past a plurality of sensors.

7. The apparatus of claim 6 wherein said dimensional characteristics are stored on a computer.

8. The apparatus of claim 7 wherein said computer controls said vertical lifting and said horizontal moving.

9. The apparatus of claim 1, wherein a first conveying means, under computer control, moves said workpiece tranversely past an edge detection means, to a laser light projection and alignment station, said apparatus comprising:
a support bar for vertically lifting one end of said workpiece, wherein said support bar is mounted to a computer controlled linear actuator;
a means for horizontally moving the other end of said workpiece, still in contact with said first conveying means, wherein said vertically lifting and horizontally moving are computer controlled;
a means for lowering said support bar to allow an operator to release said workpiece to a second conveying means for sawing.

10. The apparatus of claim 9 wherein said edge detection means comprises multiple sensors for measuring dimensional characteristics of said workpiece.

11. The apparatus of claim 10 wherein said dimensional characteristics are stored on a computer.

12. The apparatus of claim 9 wherein said first conveyor means accurately moves said workpiece under a series of laser lights, said laser lights projecting a visible plurality of parallel lines onto surface of said workpiece showing said operator an optimum rip combination based on a measured width of said workpiece.

13. The apparatus of claim 9 further comprising after said said vertically lifting and horizontally moving, means to allow the operator to fine tune the positioning of said workpiece prior to releasing to said second conveying means.

14. A method for feeding a workpiece into a saw, comprising: automatically adjusting the orientation of said workpiece before feeding said workpiece into said saw.

15. The method of claim 14, wherein said automatically adjusting said orientation of said workpiece comprises vertically lifting one end of said workpiece while horizontally moving an opposite end of said workpiece.

16. The method of claim 15 wherein a conveying means is used to move said opposite end horizontally.

17. The method of claim 16 wherein said conveying means comprises one or more chains or belts.

18. The method of claim 15 wherein said one end of said workpiece is lifted vertically by a fluid activated cylinder.

19. The method of claim 15 wherein dimensional characteristics of said workpiece are first acquired by traversing said workpiece past a plurality of sensors.

20. The method of claim 19 further comprising storing said dimensional characteristics on a computer.

21. The method of claim 20 wherein said computer controls said vertical lifting and said horizontal moving.

22. A method for automatically adjusting the orientation of a workpiece before feeding said workpiece into a saw, comprising the steps of:
placing said workpiece on to a ramp structure;
providing a computer controlled first conveying means to move said workpiece tranversely;
providing an edge detection means;
providing a laser light projection and alignment station;
vertically lifting one end of said workpiece with a support bar is mounted to a computer controlled linear actuator while horizontally moving the other end of said workpiece, still in contact with said first conveying means; and
lowering said support bar to allow an operator to release said workpiece to a second conveying means for sawing.

23. The method of claim 22 wherein said edge detection means is provided with multiple sensors to measure the dimensional characteristics of said workpiece.

24. The method of claim 22 further comprising storing said dimensional characteristics on a computer.

25. The method of claim 22 wherein after said workpiece adjustment, providing a means for an operator to fine tune the positioning of said workpiece prior to releasing said workpiece to said second conveying means.
